(19) United States
(12) Patent Application Publication
(10) Pub. No.: US 2024/0388213 A1
(43) Pub. Date: Nov. 21, 2024

(54) Secondary side peak current controlled mode flyback converter

(71) Applicant: Cypress Semiconductor Corporation, San Jose, CA (US)

(72) Inventors: Rajesh KARRI, Visakhapatnam (IN); Arun KHAMESRA, Bangalore (IN)

(73) Assignee: Cypress Semiconductor Corporation, San Jose, CA (US)

(21) Appl. No.: 18/320,804

(22) Filed: May 19, 2023

(51) Int. Cl. H02M 3/335

(52) U.S. Cl. CPC H02M 3/33592

(57) ABSTRACT

Secondary side peak current control mode flyback converters are described. In one embodiment, an apparatus includes a flyback converter including a flyback transformer and a signal transformer, a primary side including a primary-side controller coupled to a power switch, the flyback transformer and the signal transformer, and a secondary side including a secondary-side controller coupled to the flyback transformer and the signal transformer. The secondary-side controller is configured at least to operate in a current control mode to cause a pulse width modulation (PWM) signal to be generated based on a set of parameters to control operation of the primary-side controller.

A flyback converter is a system that can generate some direct current (DC) output from a given input provided by a power source. For example, the input can be an alternating current (AC) input provided by an AC source, and the flyback converter can be an AC to DC (AC-DC) flyback converter. As another example, the input can be a DC input provided by a DC source, and the flyback converter can be a DC to DC (DC-DC) flyback converter. Some flyback converters can be used to implement power adapters. For example, a power adapter can be an AC-DC power adapter to convert input AC current or voltage into DC current or voltage usable by an electronic device (i.e., load). As another example, a power adapter can be a DC-DC power adapter to convert input DC current or voltage into DC current or voltage (e.g., to regulate DC current) usable by an electronic device (e.g., by modifying the input DC current or voltage). Power adapters can support power delivery for various types of electronic devices (e.g., such as smartphones, tablets, notebook computers, laptop computers, hubs, chargers, adapters, etc.).

The power factor of a system can be defined as the ratio of the real power absorbed by the load to the apparent power flowing in a circuit. For example, the real power can be the average power representing the capacity of electricity to do work, and the apparent power can be the product of root mean square (RMS) and voltage. A power factor of less than one means that the voltage and current are out of phase. The effects of the phase difference can therefore increase total harmonic distortion (THD) of the input current. For example, THD can be defined as the ratio of the sum of the powers of all harmonic components raised to the power of the fundamental frequency. In power systems, lower THD is associated with lower peak currents, less heating, lower electromagnetic emissions, etc. A negative power factor can be caused by a load generating real power that flows back towards a power source (e.g., a load with a lower power factor can draw more current than a load with a higher power factor, ceteris paribus). The higher currents and associated peak current spikes associated with lower power factors can increase the amount of energy waste and require larger or more expensive equipment to handle.

### BRIEF DESCRIPTION OF THE DRAWINGS

The disclosure is illustrated by way of example, and not of limitation, in the figures of the accompanying drawings.

FIG. 1 is a block diagram of a high-level overview of a flyback converter, according to some embodiments.

FIG. 2 is a block diagram of a system implementing a flyback converter, according to some embodiments.

FIGS. 3A-3B are block diagrams of example systems implementing secondary side peak current controlled flyback converters, according to some embodiments.

FIG. 4 is a schematic diagram of an example secondary side circuitry of a power adapter, according to some embodiments.

FIG. 5 is a block diagram illustrating an integrated circuit (IC) system for use in power delivery, according to some embodiments.

FIG. 6 is a block diagram illustrating an example system for implementing a secondary-side peak current control mode flyback converter, according to some embodiments.

FIGS. 7A-7B are graphs illustrating example waveforms, according to some embodiments.

FIGS. 8-9 are flow diagrams of methods of implementing a secondary side peak current controlled flyback converter, according to some embodiments.

### DETAILED DESCRIPTION

Described herein are various embodiments of techniques for secondary side peak current controlled flyback converters. A flyback converter can include a primary side having a current input including a power source, at least one primary-side capacitor, a primary-side controller, and at least one primary-side switch. For example, the power source can be an AC power source. The at least one primary-side switch can include a power switch. In some embodiments, the power switch is a field-effect transistor (FET). The flyback converter can further include a secondary side having at least one secondary-side switch and at least one secondary-side capacitor, and can include or be coupled to a load. For example, the at least one secondary side switch can include a diode. A flyback transformer separates the primary side from the secondary side to enable galvanic isolation and prevent direct current flow from the primary side to the secondary side. More specifically, the flyback transformer can include a primary-side winding and a secondary-side winding.

The primary side can further include a primary-side controller coupled to the power switch to control operation of the power switch (e.g., turning the power switch on and off). By controlling operation of the power switch, the state of the flyback converter can be controlled to turn power delivery on and off. More specifically, the flyback converter can cycle between an on-state and an off-state.

For example, when the primary-side controller closes the power switch (e.g., turns the FET on), the flyback converter is placed in the on-state. While the flyback converter is in the on-state, the primary-side winding of the flyback transformer is connected to the power source, and a primary current from the power source flows toward the primary-side winding of the flyback transformer. The primary current charges the primary-side winding of the flyback transformer and increases magnetic flux incident on the secondary-side winding of the flyback transformer, which induces a negative electromotive force (emf) in the secondary-side winding of the flyback transformer in accordance with Faraday's law. The diode of the secondary side blocks current flow from the flyback transformer due to reverse-bias resulting from the negative emf. Instead, the at least one secondary-side capacitor can deliver power to the load. When the primary-side controller opens the power switch (e.g., turns the FET off), the flyback converter is placed in the off-state. While the flyback converter is in the off-state, the primary-side winding of the flyback transformer is disconnected from the power source, and the primary current from the power source stops flowing toward the primary-side winding of the flyback transformer. This decreases the magnetic flux incident on the secondary-side winding, which induces a positive emf in the secondary-side winding of the flyback transformer in accordance with Faraday's law. The diode of the secondary side allows a secondary current to flow from the flyback transformer to due forward-bias resulting from the positive emf. This secondary current is used to charge the at least one secondary-sides capacitor and deliver power to the load.

In some implementations, the secondary side further includes a secondary-side controller. The secondary-side controller can include a signal generator to generate signals. For example, a signal can include a pulse (e.g., a signal with a rapid rise time, followed by a constant voltage period, and followed by a rapid fall time). In some implementations, the secondary-side controller can utilize pulse-width modulation (PWM) to generate a PWM signal. PWM can be used to control (e.g., reduce) the amplitude of the pulse of the control signal.

In some implementations, the secondary-side controller can communicate control signals to the primary-side controller that can be used to control the power switch. More specifically, a signal transformer can be placed between the primary side and the secondary side, and the secondary-side controller can communicate control signals to the primary-side controller via the signal transformer. For example, the signal transformer can be a pulse transformer. Accordingly, the signal transformer can act as a communication link between the primary-side controller and the secondary-side controller.

The secondary-side controller can operate in accordance with a switching frequency, which can be fixed (e.g., static) or variable (e.g., dynamic). A flyback converter can be configured to operate in one or more operating modes based on the amount of time between receiving control signals in accordance with the switching frequency. The flyback converter may need to be designed to support operation in one or more of the operating modes.

One example of an operating mode is continuous conduction mode (CCM). A flyback converter operates in CCM if the primary-side controller causes the power switch to go from open to closed before the primary-side winding has had enough time to discharge completely. In other words, a control signal to close an open power switch is received by the primary-side controller before complete discharge of the primary-side winding of the flyback transformer. Thus, when operating in CCM, the current in the primary-side winding of the flyback transformer is never zero or near-zero.

Another example of an operating mode is discontinuous conduction mode (DCM). A flyback converter operates in DCM if the primary-side controller causes the power switch to go from open to closed after an amount of time sufficient to completely discharge the primary-side conductor. In other words, a control signal to close an open power switch is received by the primary-side controller after complete discharge of the primary-side winding of the flyback transformer. Thus, when operating in DCM, the current in the primary-side winding of the flyback transformer is zero or near-zero for at least some amount of time. DCM can occur if the duty cycle of the control signal is sufficiently short and/or the load is sufficiently small. A duty cycle refers to the amount of activity period during an on-off cycle for a waveform (e.g., signal) or system. Duty cycle can be determined based on a ratio of active time to total period. In some implementations, the duty cycle is expressed as a ratio (e.g., fraction or decimal). In some implementations, the duty cycle is expressed as a percentage. For example, the duty cycle of a waveform can be determined based on a ratio of a pulse width of the waveform to a total period of the signal.

Operation in DCM can be more efficient than, e.g., in CCM due at least in part to the reduced reverse recovery loss with respect to the diode. The improved efficiency can be achieved assuming that the current through the primary-side winding is efficiently delivered. For example, an appropriate duty cycle can be selected during DCM operation to improve power delivery efficiency. Moreover, flyback converters operating in DCM employ zero-current switching (ZCS) and/or zero-voltage switching (ZVS), which can further improve efficiency. However, DCM can result in larger amounts of electromagnetic interference (EMI) and/or noise as compared to CCM, so flyback converters operating in DCM may require additional circuitry to account for the EMI and/or noise.

Yet another example of an operating mode is a critical conduction mode (CrCM). A flyback converter operates in CrCM if the primary-side controller causes current to be delivered to the primary-side winding of the flyback converter upon complete discharge of the primary-side winding of the flyback converter (e.g., once the current in the primary-side winding of the flyback converter is zero). In other words, the power switch is closed (e.g., turned on) approximately immediately after the primary-side winding of the flyback converter is completely discharged. CrCM can occur by employing an appropriately chosen duty cycle for the control signal that can cause current to be delivered to the primary-side winding of the flyback converter at approximately the correct time after the power switch is opened.

A flyback converter can further optimize operation to achieve circuit protection based on analysis of current and voltage conditions and the detection of faults. In some embodiments, circuit protection includes power factor correction (PFC). To improve resource efficiency and protect the circuitry, PFC can be enabled when the amount of power is sufficiently high (e.g., greater than 75 W). More specifically, PFC can increase the power factor closer to the ideal of 1 during high-power operation. Without implementing PFC, a phase difference may exist between the current and input voltage, which can result in loss and high peak currents. PFC can be used to draw input current in phase with the input voltage. For example, PFC can maintain THD of the input current that is suitable low (e.g., less than or equal to 5% at full load).

In some implementations, a flyback converter is implemented within a power adapter. Some power adapters can support a wide power range (e.g., from about 0.1 W to about 100 W). However, a power adapter can remain in a lower power mode for most of the time (e.g., about 80% of the time). Keeping PFC enabled while the power adapter operates in a lower power mode can result in reduced efficiency. Accordingly, although PFC can be beneficial to use during higher-power operations (e.g., greater than 75 W), PFC can be viewed as unnecessary overhead for lower-power operations.

In some embodiments, a flyback converter is implemented within a power adapter. For example, the power adapter can be an AC-DC power adapter. Embodiments described herein can also be implemented in other types of power adapters, power converters, power delivery circuits, or the like. A power adapter described herein can include a power control subsystem having hardware, firmware, or any combination. A power adapter described herein can be coupled to electronic devices (e.g., loads) to enable power delivery. Examples of such electronic devices include, without limitation, personal computers (e.g., laptop computers, notebook computers, etc.), mobile computing devices (e.g., tablets, tablet computers, e-reader devices, etc.), mobile communication devices (e.g., smartphones, cell phones, personal digital assistants, messaging devices, pocket PCs, etc.), connectivity and charging devices (e.g., hubs, docking stations, adapters, chargers, etc.), audio/video/data recording and/or playback devices (e.g., cameras, voice recorders, hand-held scanners, monitors, etc.), and other similar electronic devices that can use connectors (interfaces) for communication, battery charging, and/or power delivery. Embodiments described herein can be used for AC-DC power adapters, GaN-based power adapters operating at or above 600 kHz frequencies, power adapters with primary or secondary-side controllers, power adapters operating in modes of operations, such as DCM, CCM, CrCM, quasi-resonant mode (QR), or the like.

In some embodiments, the power adapter is a Universal Serial Bus (USB) Power Delivery (USB-PD) power adapter configured to operate with a USB-enabled electronic device or system. A USB-enabled electronic device or system may comply with at least one release of a USB specification. Examples of such USB specifications include, without limitation, the USB Specification Revision 2.0, the USB 3.0 Specification, the USB 3.1 Specification, and/or various supplements (e.g., such as On-The-Go, or OTG), versions and errata thereof. The USB specifications generally define the characteristics (e.g., attributes, protocol definition, types of transactions, bus management, programming interfaces, etc.) of a differential serial bus that are required to design and build standard communication systems and peripherals. For example, a USB-enabled peripheral device attaches to a USB-enabled host device through a USB port of the host device to form a USB-enabled system. A USB 2.0 port includes a power voltage line of 5V (denoted VBUS), a differential pair of data lines (denoted D+ or DP, and D− or DN), and a ground line for power return (denoted GND). A USB 3.0 port also provides the VBUS, D+, D−, and GND lines for backward compatibility with USB 2.0. In addition, to support a faster differential bus (the USB SuperSpeed bus), a USB 3.0 port also provides a differential pair of transmitter data lines (denoted SSTX+ and SSTX−), a differential pair of receiver data lines (denoted SSRX+ and SSRX−), a power line for power (denoted DPWR), and a ground line for power return (denoted DGND). A USB 3.1 port provides the same lines as a USB 3.0 port for backward compatibility with USB 2.0 and USB 3.0 communications. Still, it extends the performance of the SuperSpeed bus by a collection of features referred to as Enhanced SuperSpeed.

A more recent technology for USB connectors, called USB Type-C™, is defined in various releases and/or versions of the USB Type-C™ specification (e.g., such as Release 1.0, Release 1.1, etc.). The USB Type-C™ specification defines Type-C™ receptacle, Type-C™ plug, and Type-C™ cables that can support USB communications as well as power delivery over newer USB power delivery protocols defined in various revisions/versions of the USB-PD specification. Examples of USB Type-C™ functions and requirements may include, without limitation, data and other communications according to USB 2.0 and USB 3.0/3.1/3.2, electro-mechanical definitions and performance requirements for Type-C™ cables, electro-mechanical definitions and performance requirements for Type-C™ receptacles, electro-mechanical definitions and performance requirements for Type-C™ plugs, requirements for Type-C™ to legacy cable assemblies and adapters, requirements for Type-C™-based device detection and interface configuration, requirements for optimized power delivery for Type-C™ connectors (also referred to as USB-C connectors), etc. According to the USB Type-C™ specification(s), a Type-C™ port provides VBUS, D+, D−, GND, SSTX+, SSTX−, SSRX+, and SSRX− lines, among others. In addition, a Type-C™ port also provides a Sideband Use (denoted SBU) line for signaling of sideband functionality and a Configuration Channel (denoted CC) line for discovery, configuration, and management of connections across a Type-C™ cable. A Type-C™ port may be associated with a Type-C™ plug and/or a Type-C™ receptacle. The Type-C™ plug and the Type-C™ receptacle are designed as a reversible pair that operates regardless of the plug-to-receptacle orientation for ease of use. Thus, a standard USB Type-C™ connector, disposed as a standard Type-C™ plug or receptacle, provides pins for four VBUS lines, four ground return (GND) lines, two D+ lines (DP1 and DP2), two D− lines (DN1 and DN2), two SSTX+ lines (SSTXP1 and SSTXP2), two SSTX− lines (SSTXN1 and SSTXN2), two SSRX+ lines (SSRXP1 and SSRXP2), two SSRX− lines (SSRXN1 and SSRXN2), two CC lines (CC1 and CC2), and two SBU lines (SBU1 and SBU2), among others. Embodiments described herein can be used in power-adapter solutions along with Type-C™ PD capability.

Some USB-enabled electronic devices may be compliant with a specific revision and/or version of the USB-PD specification (e.g., such as Revision 1.0, Revision 2.0, Revision 3.0, etc., or later revisions/versions thereof). The USB-PD specification defines a standard protocol designed to enable the maximum functionality of USB-enabled devices by providing more flexible power delivery along with data communications over a single USB Type-C™ cable through USB Type-C™ ports. The USB-PD specification also describes the architecture, protocols, power supply behavior, parameters, and cabling necessary for managing power delivery over USB Type-C™ cables at up to 100 W of power. According to the USB-PD specification, devices with USB Type-C™ ports (e.g., USB-enabled devices) may negotiate for more current and/or higher or lower voltages over a USB Type-C™ cable than are allowed in older USB specifications (e.g., the USB 2.0 Specification, USB 3.1 Specification, the USB Battery Charging Specification Rev. 1.1/1.2, etc.). For example, the USB-PD specification defines the requirements for a PD contract that can be negotiated between a pair of USB-enabled devices. The PD contract can specify both the power level and the direction of power transfer that both devices can accommodate and can be dynamically re-negotiated (e.g., without device un-plugging) upon request by either device and/or in response to various events and conditions, such as power role swap, data role swap, hard reset, failure of the power source, etc. According to the USB-PD specification, an electronic device is typically configured to deliver power to another device through a power path configured on a USB VBUS line.

With the proliferation of USB Type-C™ and USB-PD specification, a single universal charging solution has become feasible. Such a universal charging solution can utilize a programmable power supply. This has created a shift in the flyback converter controller topology from the traditionally dominated high voltage primary side to low voltage secondary side, where a microcontroller will be present and helps the end user in configuring the power output, thus creating the demand for secondary side controlled flyback converters. Although secondary-side controllers can configure the output power based on an end user requirement, secondary-side controllers can lag behind the primary-side controller in terms of power performance metrics (e.g., during CCM). One advantage that a primary-side controller has over a secondary-side controller is access to information from the primary side transformer current, which can be used to implement a current mode compensation approach rather than a voltage mode compensation approach. Generally, a compensator is a type of controller used to improve the transient response of a closed-loop system. Compensators can be used to improve the transient response of a flyback converter operating in, e.g., CCM.

A current mode compensator can include a type-2 compensator to improve the transient response of a closed-loop system by providing phase boost and gain boost to the system. For example, type-2 compensators can be used in systems with high-order dynamics or long time delays to reduce overshoot, improve settling time, and increase stability margins. However, type-2 compensators can also introduce noise amplification and limit the maximum achievable bandwidth of the system. A current mode compensator can include a resistor divider including a first resistor and a second resistor, a fixed reference voltage, an error amplifier (e.g., a current error amplifier) and a resistor-capacitor (RC) network including a third resistor, a first capacitor and a second capacitor. The error amplifier can generate an output corresponding to a duty cycle by comparing the fixed reference value to an output reference value provided by the resistor divider.

A voltage mode compensator can include a type-3 compensator to improve the steady-state response of a closed-loop system by providing phase lag and gain reduce to the system. For example, a type-3 compensator can be used in a system with low-frequency disturbances or reference inputs to improve the steady-state accuracy and reduce the steady-state error of the system. However, type-3 compensators can also introduce phase delay and limit the maximum achievable bandwidth of the system. A voltage mode compensator can include the resistor divider, the fixed reference voltage, the error amplifier, and the RC network similar to the current mode compensator. In addition, the voltage mode compensator can include a second RC network that includes the first resistor, a fourth resistor, and a third capacitor.

With respect to flyback converters, a voltage mode controller and a current mode controller can be differentiated by their PWM ramp generation source. A current mode controller PWM ramp can be dependent on a transformer current, whereas the voltage mode controller can be independent of the transformer current. Thus, a current mode controller can control or maintain the current through the transformer every cycle to improve the system transient response.

Existing secondary-side controlled flyback converters can utilize voltage mode controllers due to the current through the transformer not being accessible by the secondary-side controller. The PWM signal is generated by the secondary-side controller from a fixed DC starting point and ramps up with time to generate a saw tooth wave. Such a signal can be completely independent of the current through the primary-side. However, a current mode compensation can be superior to voltage mode compensation in terms of compensation, better transient response and ease of stabilizing the loop. For example, type-2 compensators can offer simplified loop designs for flyback converter controllers as compared to type-3 compensators. Additionally, it may be challenging to stabilize a type-3 system in a flyback converter and can require sacrificing of the transient response to meet the stability criteria. This can lead to large overshoot/undershoot and a very slow response in CCM secondary-side controlled designs compared to primary-side controlled designs and is a factor regarding controller type when designing controllers for higher power.

Described herein are various embodiments of techniques for secondary side peak current controlled mode flyback converters. Embodiments described herein provide flyback converters that are designed to operate in a current mode, as opposed to a voltage mode, to improve the transient response and decrease the complexity in achieving stabilization. Embodiments described herein provide for secondary-side controlled flyback converters that can achieve improved response to line and load transients, comparable to primary-side controlled flyback converters. Moreover, embodiments described herein can be used to reduce the number of additional components that are needed for stabilizing the system.

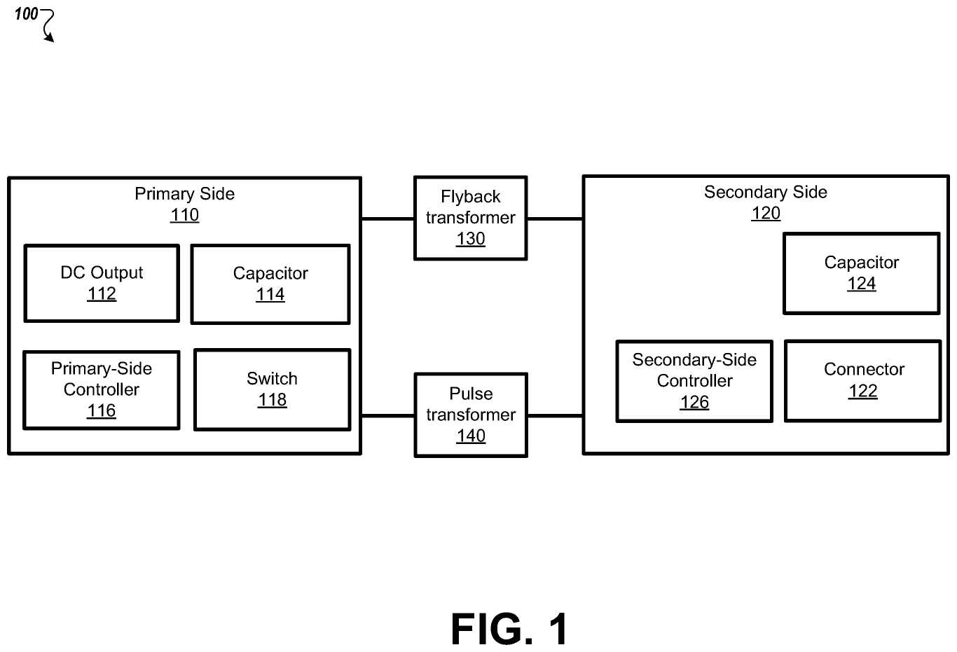

For example, a secondary-side controller described herein can generate a PWM signal from a derived line and load parameters on the secondary side. A feedforward block coupled to a sense node (e.g., SR drain node) can be used to generate a current based on the input voltage (V_{IN}), which can be used to ramp up the waveform when the primary side is on, a current based on the output voltage (V_{OUT}) can be used to ramp down the waveform. Since the transformer current is also dependent on these parameters, the generated waveform can represent a scaled replica of the transformer current, thereby controlling the transformer current every cycle and converting the control loop to current mode. The DC starting value used for the next cycle can be based on the residual current in every cycle, which can be an important parameter in, e.g., CCM operation. Further details regarding secondary side peak current controlled mode flyback converters will be described below with reference to FIGS. 1-9.

Advantages of secondary side peak current controlled mode flyback converters, as described herein, include improved secondary-side controller efficiency, reduced resource consumption, reduced stress on electrical components, increased flexibility, and programmability. There may not be a right hand plane (RHP) zero of the transfer function of the system, which can make it easy to stabilize the system. Embodiments described herein can reduce the number of external components per board, as well as reduce the number of pins as there is no need for type-3 compensation in CCM cases. Embodiments described herein can increase portability by not requiring an additional external component between DCM and CCM boards. Additionally, since PFC is controlled by the secondary-side controller, the primary-side controller can be designed with minimal intelligence and the overall footprint of the flyback converter can be reduced. Accordingly, embodiments described herein can be used to fabricate systems and devices implementing flyback converters (e.g., power adapters) with smaller footprints and less circuitry, which can reduce manufacturing costs and increase efficiency.

FIG. 1 is a block diagram of flyback converter 100, according to some embodiments. In some embodiments, flyback converter 100 is included within a power adapter. For example, the power adapter can be an AC-DC power adapter. For example, the power adapter can be a USB-PD power adapter. In some embodiments, other converters may be used, e.g., a switching converter, or the like.

Flyback converter 100 can include primary side 110, secondary side 120, flyback transformer 130, and pulse transformer 140. As shown, primary side 110 can include DC output component 112, capacitor 114, primary-side controller 116, and switch 118. More specifically, switch 118 is a power switch controllable by primary-side controller 116. In some embodiments, switch 118 is a FET. Secondary side 120 can include (or be coupled to) connector 122, capacitor 124, and secondary-side controller 126. In some embodiments, connector 122 represents an electronic device connected to flyback converter 100. For example, connector 122 can represent an electronic device connected to a power adapter implementing flyback converter 100.

Flyback transformer 130 can have a primary-side winding coupled to primary side 110 and a secondary-side winding coupled to secondary side 120. For example, DC output component 112 can be coupled to a first end of the primary-side winding, and switch 118 can be coupled to a second end of the primary-side winding. For example, if switch 118 is a FET, then the second end of the primary winding of flyback transformer 130 can be coupled to a source/drain of switch 118. For example, a first end of the secondary-side winding can be coupled to a diode, and a second end of the secondary-side winding can be coupled to an output line. Pulse transformer 140 can have a primary-side winding coupled to primary side 110 and a secondary-side winding coupled to secondary side 120.

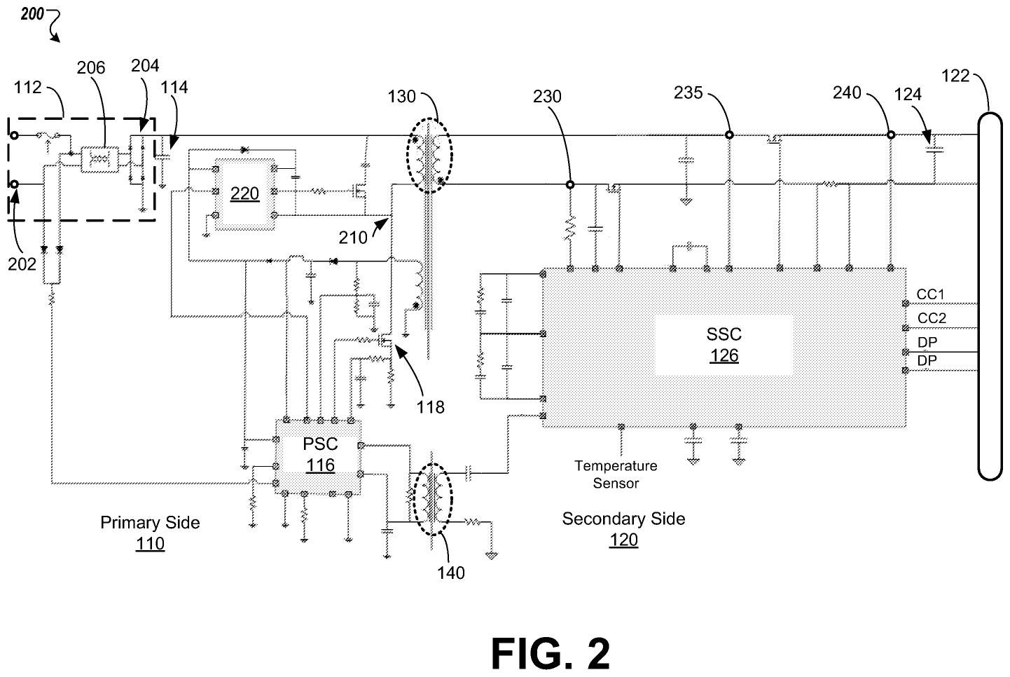

An example operation of flyback converter 100 will now be described. DC output component 112 can receive an AC input from an AC input source and convert the AC input into a corresponding DC output. Further details regarding DC output component 112 are described below with reference to FIG. 2.

Primary-side controller 116 can control operation of switch 118 to control a state of flyback converter 100. For example, when primary-side controller 116 closes switch 118 (e.g., turns the FET on), flyback converter 100 is placed in the on-state. While flyback converter 100 is in the on-state, the DC output generated by DC output component 112 flows toward the primary-side winding of flyback transformer 130. The DC output generated by DC output component 112 charges the primary-side winding of flyback transformer 130 and increases magnetic flux incident on the secondary-side winding of flyback transformer 130, which induces a negative emf in the secondary-side winding of flyback transformer 130 in accordance with Faraday's law. Current flow from flyback transformer 130 can be blocked due to reverse-bias resulting from the negative emf. Instead, capacitor 124 can deliver power to connector 122. When primary-side controller 116 opens switch 118 (e.g., turns the FET off), flyback converter 100 is placed in the off-state. While flyback converter 100 is in the off-state, the primary-side winding of flyback transformer 130, the DC output generated by DC output component 112 stops flowing toward the primary-side winding of flyback transformer 130. This decreases the magnetic flux incident on the secondary-side winding of flyback transformer 130, which induces a positive emf in the secondary-side winding of flyback transformer 130 in accordance with Faraday's law. Current flow from flyback transformer 130 can be allowed to due forward-bias resulting from the positive emf. This secondary current is used to charge capacitor 124 and deliver power to connector 122.

Secondary-side controller 126 can include a signal generator to generate signals. For example, a signal can include a pulse. A pulse can have a fixed width or a variable width. In some embodiments, secondary-side controller 126 utilizes PWM to generate a PWM signal. In some embodiments, secondary-side controller 126 can communicate control signals to primary-side controller 116 that can be used to control switch 118. More specifically, secondary-side controller 126 can communicate control signals to the primary-side controller via signal transformer 140.

Control signals generated by secondary-side controller 126 can, upon receipt by primary-side controller 116, cause primary-side controller 116 to control operation of switch 118. For example, in response to receiving a turn-on control signal, primary-side controller 116 can cause switch 118 to close (e.g., turn on the FET). In response to receiving a turn-off control signal, primary-side-controller 116 can cause switch 118 to open (e.g., turn off the FET). For example, if switch 118 is a FET, then primary-side controller 116 can apply a turn-on voltage (e.g., pulse) to the gate of switch 118 to turn on switch 118 (e.g., cause the source/drain of switch 118 to go low). In some embodiments, the turn-on voltage is about 12V. Primary-side controller 116 can apply a turn-off voltage (e.g., pulse) to the gate of switch 118 to turn off switch 118 (e.g., cause the source/drain of switch 118 to go high).

In some embodiments, primary-side controller 116 includes a comparator or differential amplifier having a pair of input terminals connected to signal transformer 140, and an output terminal connected to switch 118. The comparator can generate an output signal based on a pair of input signals received from signal transformer 140, which can be used to control switch 118.

Secondary-side controller 126 can send any combination of pulses indicating a specific bit pattern to primary-side controller 116, without requiring clock synchronization. In one embodiment, secondary-side controller 126 includes a state machine to synchronize each function of primary-side controller 116 to be programmed (e.g., calibrated, trimmed, or the like). Secondary-side controller 126 can store other information, such as user-defined settings. For example, the user-defined settings pertaining to the primary-side functionality, such as over-voltage (OV), under-voltage (UV), over-current (OC), short-circuit detection, over-temperature (OT), line voltage, peak current limits, or the like, can be stored in the non-volatile memory of secondary-side controller 126. Firmware of secondary-side controller 126 can transfer this information to primary-side controller 116 in a similar manner at appropriate times, such as at boot-up or later during the operation of the converter at a specific time. During a no-load case, information regarding the turning on of switch 118 is not required to be sent.

Secondary-side controller 126 can generate control signals in accordance with a switching frequency, which can be fixed (e.g., static) or variable (e.g., dynamic). Flyback converter 100 can be configured to operate in one or more operating modes based on the amount of time between receiving control signals in accordance with the switching frequency. Flyback converter 100 may need to be designed to support operation in one or more of the operating modes. For example, flyback converter 100 can operate in CCM. As another example, flyback converter 100 can operate in DCM.

Secondary-side controller 126 can operate in a current mode instead of a voltage mode to improve transient response and decrease complexity in stabilizing flyback converter 100. For example, secondary-side controller 126 can obtain a set of parameters including Lₚᵣᵢ, L_{sec}, V_{IN} and V_{OUT}. Lₚᵣᵢ is the primary inductance with respect to flyback transformer 130 and L_{sec} is the secondary inductance with respect to flyback transformer 130. V_{IN} is an input voltage value corresponding to the AC voltage input, and V_{OUT} is an output DC voltage value. In some embodiments, V_{IN} is a root mean square (RMS) value derived from AC voltage inputs. In some embodiments, V_{OUT} corresponds to VBUS.

Lₚᵣᵢ and L_{sec} can be obtained from firmware. V_{IN} can be detected by feedforward circuitry coupled to a sense node on the secondary side. V_{OUT} can be obtained from an error amplifier or firmware. As will be described in further detail, this information can be used to generate a PWM signal ramp with a rate (i.e., slope) determined based on V_{IN} or V_{OUT}. For example, when switch 118 is turned on, a primary current waveform can be ramped up to generate a ramped up waveform with a rate (i.e., slope) proportional to a ratio of V_{IN} and Lₚᵣᵢ (e.g., V_{IN}/Lₚᵣᵢ) until switch 118 is turned off. When switch 118 is turned off, a secondary current waveform can be ramped down to generate a ramped down waveform with a rate proportional to a ratio of V_{OUT} and L_{sec} (e.g., V_{OUT}/L_{sec}) until either the SR switch is turned off (in the case of CCM operation) or detecting a zero-crossing using zero-crossing detection (ZCD) (in case of DCM operation). ZCD is a technique used to detect the moment when a voltage waveform or signal crosses the zero-voltage line. ZCD can be accomplished by measuring the voltage waveform and detecting the point where it changes sign from positive to negative or vice versa. ZCD can be performed using a comparator circuit or a microcontroller with an analog-to-digital converter (ADC). A residual voltage determined as the difference between the ramped up waveform and the ramped down waveform can then be set as the starting value used by primary-side controller 116 for the next cycle. Further details regarding flyback converter 100 will now be described below with reference to FIG. 2.

FIG. 2 is a block diagram of system 200, according to some embodiments. In some embodiments, system 200 includes a power adapter. For example, system 200 can include a USB-PD power adapter. System 200 includes a flyback converter, such as flyback converter 100. In some embodiments, flyback converter 100 is an ACF flyback converter including an ACF to operate in an ACF mode.

For example, system 200 can include primary side 110 having DC output component 112, capacitor 114, primary-side controller 116, switch 118, and primary drain node (PDN) 210. In some embodiments, and as shown in FIG. 2, switch 118 is a FET. System 200 can further include driver 220. In some embodiments, driver 220 is an active clamp flyback (AFC) driver to form at least a portion of an active clamp of the flyback converter. In some embodiments, driver 220 can be a gate driver. System 200 can further include secondary side 120, which can include or be coupled to a load through connector 122, capacitor 124, and secondary-side controller 126. Secondary side 120 can further include sense node (SR_NODE) 230 and VBUS node 240. In some embodiments, sense node 230 is a drain node (SR_DRAIN). In this illustrative example, connector 122 is a USB connector (e.g., USB Type-C™ connector).

In some embodiments, DC output component 112 can be coupled to AC source 202 providing an AC input. For example, DC output component 112 can include rectifier 204, coupled to AC source 202, to generate a DC output from the AC input received from AC source 202. In some embodiments, rectifier 204 is a bridge rectifier, including a set of diodes. In the illustrative example shown in FIG. 2, rectifier 204 is a bridge rectifier, including four diodes. However, such an example should not be considered limiting. In some embodiments, and as shown in FIG. 2, DC output component 112 can further include EMI filter 206.

System 200 can further include flyback transformer 130 and signal (e.g., pulse) transformer 140. Flyback transformer 130 can have any suitable polarity between its primary-side winding and its secondary-side winding. The polarity of a transformer can correspond to a phase-shift implemented by the transformer between its primary-side winding and its secondary-side winding. In some embodiments, and as indicated by the dot orientation, flyback transformer 130 implements 180° phase-shift between the primary-side winding and the secondary-side winding (i.e., current/voltage for one winding rises while current/voltage for the other winding falls).

Signal transformer 140 can have any suitable polarity between its primary-side winding and its secondary-side winding. In some embodiments, and as indicated by the dot orientation, signal transformer 140 implements 0° phase-shift between the primary-side winding and the secondary-side winding (i.e., current/voltage for both windings rise and fall together). Accordingly, in some embodiments, system 200 includes an AC-DC power adapter implementing an AC-DC flyback converter.

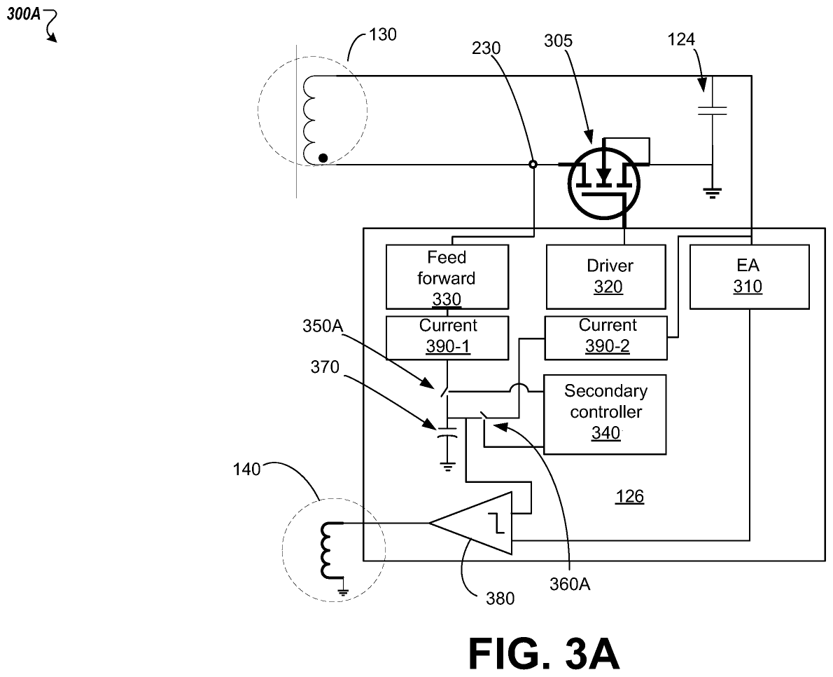

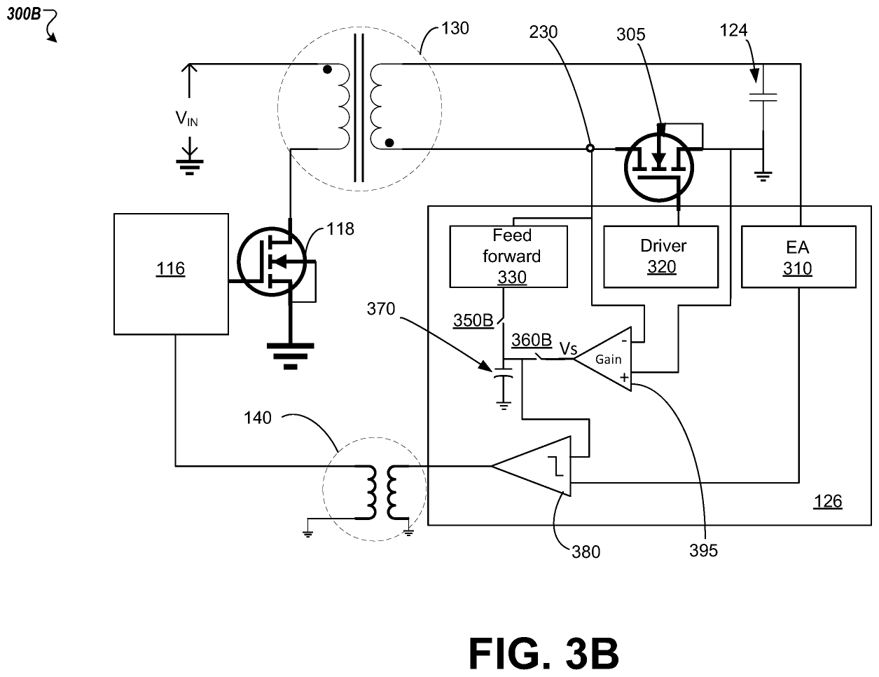

In some embodiments, secondary-side controller 126 implements a firmware-based pulse width scheme in a current mode based on a set of parameters including V_{IN} and V_{OUT}. V_{IN} is an input voltage value corresponding to AC source 202, and V_{OUT} is an output voltage value. In some embodiments, V_{IN} is an RMS value derived from AC voltage inputs. In some embodiments, V_{OUT} corresponds to VBUS_IN node 235. More specifically, the firmware-based pulse width scheme in a current mode can be implemented based on information derived from sense node 230 and VBUS node 240. For example, and as will now be described in further detail below with reference to FIGS. 3A and 3B, secondary-side controller 126 can include a flyback controller operatively coupled to a subsystem that can obtain a set of subsystem parameters including information derived from sense node 230 and VBUS node 240, and firmware that can maintain a set of functions for determining a set of output parameters based at least in part on the set of subsystem parameters

FIG. 3A is a block diagram of an example secondary side 300A of a flyback converter supporting operation in a current mode, according to some embodiments. For example, secondary side 300A can correspond to secondary side 120 of FIG. 1 and/or FIG. 2. For example, referring back to FIG. 3A, secondary side 300A can include at least one capacitor 124, secondary-side controller 126, flyback transformer 130, signal (e.g., pulse) transformer 140 and sense node 230. As further shown, secondary-side controller 126 can include or be coupled to switch 305, error amplifier (EA) 310, driver 320 coupled to switch 305, feedforward circuitry 330 coupled to sense node 230, secondary controller 340, switches 350A and 360A, capacitor 370 and comparator 380. For example, switch 305 can be an SR FET and driver 320 can be a gate driver corresponding to the SR FET.

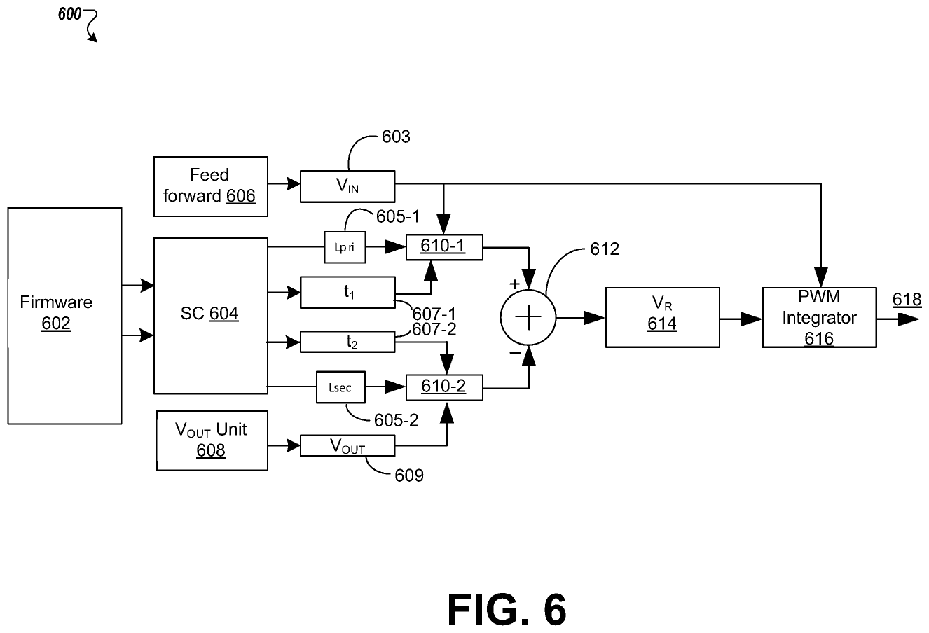

Secondary-side controller 126 can obtain a set of parameters including Lₚᵣᵢ, L_{sec}, V_{IN} and V_{OUT}. As will be described in further detail below with reference to FIG. 6, Lₚᵣᵢ and L_{sec} can be obtained from firmware. Referring back to FIG. 3A, V_{IN} can be obtained from feedforward circuitry 330 via sense node 230. V_{OUT} can be obtained from EA 310 or firmware. Current 390-1 is a current generated based on V_{IN}/Lₚᵣᵢ) and current 390-2 is a current generated based on V_{OUT}/L_{sec}). Current 390-1 charges capacitor 370 when the power switch on the primary side is turned on (e.g., switch 118 of FIGS. 1 and 2) and current 390-2 discharges capacitor 370 until SR FET 305 is turned off (in the case of CCM operation) or detecting a zero-crossing using ZCD (in the case of DCM operation). More specifically, when the power switch is turned on, switch 350A is turned on and the current 390-1 will be charging the capacitor 370 to generate a ramp voltage waveform with a rate (i.e., slope) proportional to a ratio of V_{IN} and Lₚᵣᵢ (e.g., V_{IN}/Lₚᵣᵢ) until switch 350A is turned off. When switch 350A is turned off, switch 360A is turned on, and current 390-2 can be used to discharge the ramp voltage waveform with a rate proportional to a ratio of V_{OUT} and L_{sec} (e.g., V_{OUT}/L_{sec}) until either switch 305 is turned off or detecting a zero-crossing using ZCD. The residual voltage between the ramped up ramp voltage waveform and the ramped down ramp voltage waveform can then be set as the starting value for the next cycle (e.g., in CCM operation).

Comparator 380 can generate an output signal having an associated duty cycle, which can be set by the output of EA 310. An output terminal of comparator 380 is connected to a first end of the secondary-side winding of signal transformer 140. A second end of the secondary-side winding can be connected to ground. In response to receiving the output of comparator 380, signal transformer 140 can generate a control signal in accordance with Faraday's law that travels to the primary side (e.g., primary side 110 of FIGS. 1 and 2) to control the state of the flyback converter (e.g., on-state or off-state).

FIG. 3B is a block diagram of an example secondary side 300B of a flyback converter supporting operation in a current mode, according to some embodiments. For example, secondary side 300B can correspond to secondary side 120 of FIG. 1 and/or FIG. 2. For example, referring back to FIG. 3A, secondary side 300B can include at least one capacitor 124, secondary-side controller 126, flyback transformer 130, signal (e.g., pulse) transformer 140 and sense node 230. As further shown, secondary-side controller 126 can include SR FET 305 error amplifier (EA) 310, driver 320 (e.g., gate driver 320) coupled to switch 305 (e.g., SR FET), feedforward circuitry 330 coupled to sense node 230, switches 350B and 360B, capacitor 370 and comparator 380, similar to FIG. 3A. Referring back to FIG. 3B, secondary-side controller 126 can further include gain amplifier 395.

Secondary-side controller 126 can obtain a set of parameters including Lₚᵣᵢ, L_{sec}, V_{IN} and V_{OUT}. As will be described in further detail below with reference to FIG. 6, Lₚᵣᵢ and L_{sec} can be obtained from firmware. Referring back to FIG. 3B, V_{IN} can be detected by feedforward circuitry 330 via sense node 230. V_{OUT} can be obtained from EA 310 or firmware. Switch 350B is turned on when the power switch on the primary side is turned on (e.g., switch 118 of FIGS. 1 and 2) turns-on and ramps up the PWM, whereas the switch 360B is turned on once the power switch is turned off until either the SR FET is turned off or a zero-crossing is detected using ZCD. This will bring down the voltage of capacitor 370 to a starting voltage which is proportional to the starting current of the next cycle. This emulates the primary current with a scaling factor decided by the gain of feedforward circuitry 330 and gain amplifier 395. This signal can be used as a PWM ramp, effectively converting the loop to be a current mode control type.

Comparator 380 can generate an output signal having an associated duty cycle which can be set by the output of EA 310. An output terminal of comparator 380 is connected to a first end of the secondary-side winding of signal transformer 140. A second end of the secondary-side winding can be connected to ground. In response to receiving the output of comparator 380, signal transformer 140 can generate a control signal in accordance with Faraday's law that travels to the primary side (e.g., primary side 110 of FIGS. 1 and 2) to control the state of the flyback converter (e.g., on-state or off-state).

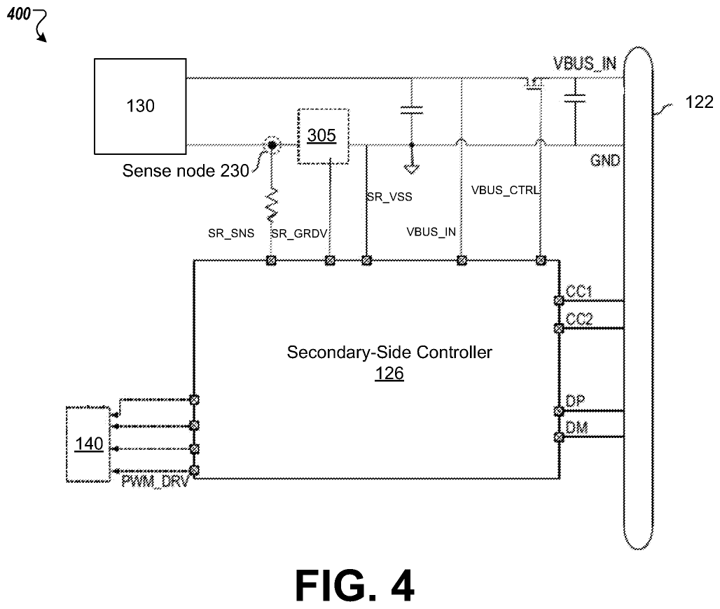

FIG. 4 is a schematic diagram of an example portion of a system 400 implementing a flyback converter, according to some embodiments. More specifically, the portion of the system includes a secondary side of the flyback converter. In some embodiments, system 400 includes a power adapter. For example, system 400 can include a USB-PD power adapter. As shown, system 400 can include connector 122 secondary-side controller 126, flyback transformer 130, signal transformer 140, sense node 230, and switch 305, as described above with reference to FIGS. 1-3B.

In this example, secondary-side controller 126 may be disposed as an integrated circuit (IC) chip that includes a subsystem configured in accordance with the techniques described herein. Secondary-side controller 126 can negotiate a PD contract with a consumer electronic device (“consumer device”) (not shown) that can represent a load attached to connector 122. Connector 122 is typically associated with a plug (e.g., USB Type-C™ plug), but it should be understood that, in various embodiments, connector 122 may be associated with a receptacle instead (e.g., USB Type-C™ receptacle).

Secondary-side controller 126 can be coupled to a VBUS_IN line and is configured to control the operation and state of power switches when fault conditions are detected by providing control signals to the gate of the switches. VBUS_IN line can include a provider switch configured as an on/off switch device controlled by signals from an output pin (“VBUS_Control”) of a gate driver in secondary-side controller 126. The provider switch can include a FET. On one side of the provider switch, a power source node on the VBUS_IN line can be coupled to flyback transformer 130, which is coupled to a large bulk capacitor configured to remove the AC component of the power signal. A power source node can be coupled to an input pin (“VBUS_IN” pin) of secondary-side controller 126. An output node on the VBUS_IN line is coupled to connector 122 and another input pin (“VBUS_CTRL” pin) of secondary-side controller 126.

In operation, the direction of power flow on the VBUS_IN line is from flyback transformer 130 to the consumer device that is attached to connector 122. When a PD contract with the consumer device is negotiated, secondary-side controller 126 can cause power to be provided to the consumer device at the negotiated voltage and/or current level(s) (e.g., via the provider switch). A high-to-low voltage transition on the VBUS_IN line may be needed when the PD contract is dynamically re-negotiated to lower the VBUS voltage and/or current, e.g., when the consumer device has finished charging its battery and now needs power only to operate.

On detection of fault conditions, a control signal may be sent to disconnect connector 122 from the flyback transformer 130. For example, the provider switch can be turned off by driving the output of VBUS_CTRL to zero. This disconnection may be caused by an over-voltage condition, an over-current condition, or other conditions that may require disconnection of connector 122 from the flyback transformer 130 for protection of circuits coupled to connector 122.

Embodiments described herein can be implemented in a power delivery system, such as a serial bus-compatible power supply device. An example of a serial bus-compatible power supply device may include a serial bus power delivery (SBPD) device, a USB-compatible power supply device, or the like. In some embodiments, an SBPD device is a USB-PD device that is compatible with the USB-PD standard or, more generally, with the USB standard. For example, the SBPD device may provide an output voltage (e.g., VBUS, power supply voltage) based on an input voltage (e.g., VBUS, power supply voltage). The SBPD device may include the various embodiments described herein to facilitate communications between a primary-side controller and a secondary-side controller. The SBPD device may include a power converter (e.g., an AC-DC converter) and a power control analog subsystem (e.g., a USB-PD controller). The power control analog subsystem may include the circuitry, functionality, or both, as described herein for communicating information across a galvanic isolation barrier. The information can include information for different functions, such as OVP (over-voltage protection), UVP (under-voltage protection), OCP (over current protection), SCP (short circuit protection), PFC (power factor correction), SR (synchronous rectification), ACF (active clamp flyback), or the like. The information can include fault information for any of these different functions.

In other embodiments, the SBPD device is connected to a power source, such as a wall socket power source that provides input power. For example, a power source can be an AC source that provides AC input. In other embodiments, the power source may be a different power source, such as a battery, and may provide DC power to the SBPD device. The power converter may convert the power received from the power source (e.g., convert power received to VBUS). For example, a power converter may be an AC-DC converter and convert AC power from the power source to DC power. In some embodiments, the power converter is a flyback converter, such as a secondary-controlled flyback converter, that provides galvanic isolation between the input (e.g., primary-side) and the output (e.g., secondary-side). For example, the secondary-controlled flyback converter may be a single-ended forward converter. In some embodiments, feedforward information on the secondary-side can be used to limit the maximum duty cycle that can be passed to the primary-side FET. The maximum duty cycle may change with line voltage.

In some embodiments, the SBPD device provides VBUS to a sink device (e.g., via a configuration channel (CC) specifying a particular output voltage, and possibly an output current). SBPD device may also provide access to ground potential (e.g., ground) to the sink device. In some embodiments, the providing of the VBUS is compatible with the USB-PD standard. Power control analog subsystem may receive VBUS from the power converter. The power control analog subsystem may output VBUS. In some embodiments, the power control analog subsystem is a USB Type-C™ controller compatible with the USB Type-C™ standard. The power control analog subsystem may provide system interrupts responsive to the VBUS and/or VBUS_CTRL.

In some embodiments, any of the components of the SBPD device may be part of an IC, or alternatively, any of the components of the SBPD device may be implemented in its own IC. For example, the power converter and power control analog subsystem may be discrete ICs with separate packaging and pin configurations.

In some embodiments, the SBPD device may provide a complete USB Type-C™ and USB-PD port control solution for notebooks, dongles, monitors, docking stations, power adapters, vehicle chargers, power banks, mobile adaptors, and the like.

Embodiments when using isolation or level shifters may require some driver circuit. The driver circuit may be as simple as using a PWM output from the secondary-side controller to drive a capacitive coupled controller or opto-coupler (also referred to as an optocoupler). The driver circuit can be an elaborate structure when driving a signal transformer.

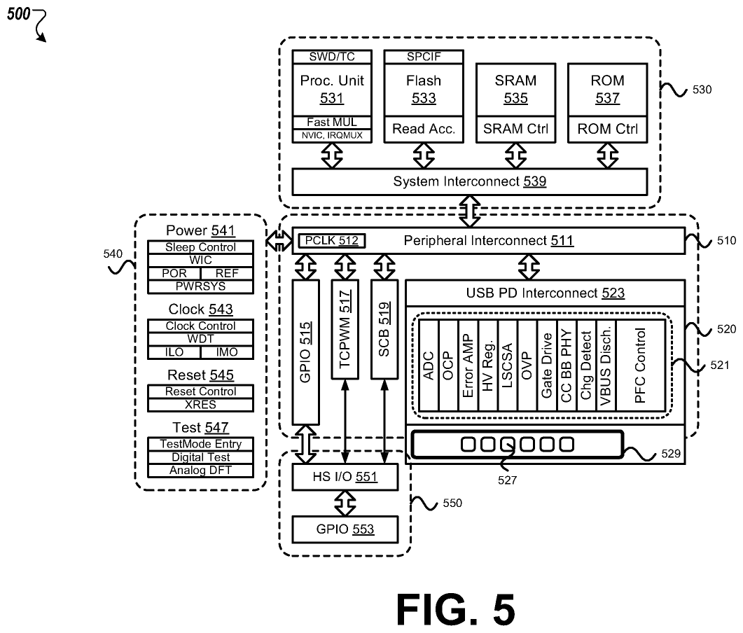

FIG. 5 is a block diagram illustrating an integrated circuit (IC) system 500 for a USB-enabled device for use in USB power delivery, according to some embodiments. System 500 may include a peripheral subsystem 510, including a number of components for use in USB Power Delivery (USB-PD). Peripheral subsystem 510 may include a peripheral interconnect 511, including a clocking module and a peripheral clock (PCLK) 512 for providing clock signals to the various components of peripheral subsystem 510. Peripheral interconnect 511 may be a peripheral bus, such as a single-level or multi-level advanced high-performance bus (AHB), and may provide a data and control interface between peripheral subsystem 510, central processing unit (CPU) subsystem 530, and system resources 540. Peripheral interconnect 511 may include controller circuits, such as direct memory access (DMA) controllers, which may be programmed to transfer data between peripheral blocks without input by, control of, or burden on CPU subsystem 530.

The peripheral interconnect 511 may be used to couple components of peripheral subsystem 510 to other components of system 500. Coupled to peripheral interconnect 511 may be a number of general-purpose input/outputs (GPIOs) 515 for sending and receiving signals. GPIOs 515 may include circuits configured to implement various functions such as pull-up, pull-down, input threshold select, input and output buffer enabling/disable, single multiplexing, etc. Still, other functions may be implemented by GPIOs 515. One or more timer/counter/pulse-width modulator (TCPWM) 517 may also be coupled to the peripheral interconnect and include circuitry for implementing timing circuits (timers), counters, pulse-width modulators (PWMs) decoders, and other digital functions that may operate on I/O signals and provide digital signals to system components of system 500. Peripheral subsystem 510 may also include one or more serial communication blocks (SCBs) 519 for implementation of serial communication interfaces such as I2C, serial peripheral interface (SPI), universal asynchronous receiver/transmitter (UART), controller area network (CAN), clock extension peripheral interface (CXPI), etc.

For USB power delivery applications, peripheral subsystem 510 may include a USB power delivery subsystem 520 coupled to the peripheral interconnect 511 and comprising a set of USB-PD modules 521 for use in USB power delivery. USB-PD modules 521 may be coupled to the peripheral interconnect 511 through a USB-PD interconnect 523. USB-PD modules 521 may include an analog-to-digital conversion (ADC) module for converting various analog signals to digital signals; an error amplifier (AMP) regulating the output voltage on the VBUS_IN line per a PD contract; a high-voltage (HV) regulator for converting the power source voltage to a precise voltage (such as 3.5-5V) to power system 500; a low-side current sense amplifier (LSCSA) for measuring load current accurately, an over-voltage protection (OVP) module and an over-current protection (OCP) module for providing over-current and over-voltage protection on the VBUS_IN line with configurable thresholds and response times; one or more gate drivers for external power field-effect transistors (FETs) used in USB power delivery in provider and consumer configurations; and a communication channel PHY (CC BB PHY) module for supporting communications on a Type-C™ configuration channel (CC) line. USB-PD modules 521 may also include a charger detection module for determining that a charging circuit is present and coupled to system 500 and a VBUS discharge module for controlling the discharge of voltage on VBUS. The discharge control module may be configured to couple to a power source node on the VBUS_IN line or to an output (power sink) node on the VBUS_IN line and to discharge the voltage on the VBUS_IN line to the desired voltage level (i.e., the voltage level negotiated in the PD contract). USB power delivery subsystem 520 may also include pads 527 for external connections and electrostatic discharge (ESD) protection circuitry 529, which may be required on a Type-C™ port. USB-PD modules 521 may also include a communication module for retrieving and communicating information, such as control signals from a secondary-side controller to a primary-side controller.

GPIO 515, TCPWM 517, and SCB 519 may be coupled to an input/output (I/O) subsystem 550, which may include a high-speed (HS) I/O matrix 551 coupled to a number of GPIOs pins 553. GPIOs 515, TCPWM 517, and SCB 519 may be coupled to GPIOs pins 553 through HS I/O matrix 551.

System 500 may also include a central processing unit (CPU) subsystem 530 for processing commands, storing program information, and storing data. CPU subsystem 530 may include one or more processing units 531 for executing instructions and reading from and writing to memory locations from a number of memories. Processing unit 531 may be a processor suitable for operation in an integrated circuit (IC) or a system-on-chip (SOC) device. In some embodiments, processing unit 531 may be optimized for low-power operation with extensive clock gating. In this embodiment, various internal control circuits may be implemented for processing unit operation in various power states. For example, processing unit 531 may include a wake-up interrupt controller (WIC) configured to wake the processing unit up from a sleep state, allowing power to be switched off when the IC or SOC is in a sleep state. CPU subsystem 530 may include one or more memories, including a flash memory 533, static random access memory (SRAM) 535, and a read-only memory (ROM) 537. Flash memory 533 may be a non-volatile memory (NAND flash, NOR flash, etc.) configured for storing data, programs, and/or other firmware instructions. Flash memory 533 may include a read accelerator and may improve access times by integration within CPU subsystem 530. SRAM 535 may be a volatile memory configured for storing data and firmware instructions accessible by processing unit 531. ROM 537 may be configured to store boot-up routines, configuration parameters, and other firmware parameters and settings that do not change during the operation of system 500. SRAM 535 and ROM 537 may have associated control circuits. Processing unit 531 and the memories may be coupled to a system interconnect 539 to route signals to and from the various components of CPU subsystem 530 to other blocks or modules of system 500. System interconnect 539 may be implemented as a system bus, such as a single-level or multi-level AHB. System interconnect 539 may be configured as an interface to couple the various components of CPU subsystem 530 to each other. System interconnect 539 may be coupled to peripheral interconnect 511 to provide signal paths between the components of CPU subsystem 530 and peripheral subsystem 510.

System 500 may also include a number of system resources 540, including a power module 541, a clock module 543, a reset module 545, and a test module 547. Power module 541 may include a sleep control module, a wake-up interrupt control (WIC) module, a power-on-reset (POR) module, a number of voltage references (REF), and a power system (PWRSYS) module. In some embodiments, power module 541 may include circuits that allow system 500 to draw and/or provide power from/to external sources at different voltage and/or current levels and support controller operation in different power states, such as active, low-power, or sleep. In various embodiments, more power states may be implemented as system 500 throttles back operation to achieve a desired power consumption or output. Clock module 543 may include a clock control module, a watchdog timer (WDT), an internal low-speed oscillator (ILO), and an internal main oscillator (IMO). Reset module 545 may include a reset control module and an external reset (XRES) module. Test module 547 may include a module to control and enter a test mode as well as testing control modules for analog and digital functions (digital test and analog DFT).

System 500 may be implemented in a monolithic (e.g., single) semiconductor die. In other embodiments, various portions or modules of system 500 may in implemented on different semiconductor dies. For example, memory modules of CPU subsystem 530 may be on-chip or separate. In other embodiments, separate-die circuits may be packaged into a multi-chip module.

System 500 may be implemented in a number of application contexts to provide USB-PD functionality thereto. In each application context, an IC controller or SOC implementing system 500 may be disposed and configured in an electronic device (e.g., a USB-enabled device) to perform operations in accordance with the single-stage, secondary-side controlled techniques described herein. In one example embodiment, a system 500 may be disposed and configured in a personal computer (PC) power adapter for a laptop, a notebook computer, etc. In another example embodiment, system 500 may be disposed and configured in a power adapter (e.g., a wall charger) for a mobile electronic device (e.g., a smartphone, a tablet, etc.). In another example embodiment, system 500 may be disposed and configured in a wall socket that provides power over USB Type-A and/or Type-C™ port(s). In another example embodiment, system 500 may be disposed and configured in a power bank that can get charged and then provide power to another electronic device over a USB Type-A or Type-C™ port. In other embodiments, a system like system 500 may be configured with power switch control circuitry and may be disposed in various other USB-enabled electronic or electro-mechanical devices.

It should be understood that a system, like system 500 implemented on or as an IC controller, may be disposed into different applications, which may differ with respect to the type of power source being used and the direction in which power is being delivered. For example, in the case of a mobile power adapter, the power source is an AC wall socket. Further, in the case of a PC power adapter, the flow of power delivery is from a provider device to a consumer device, while in the case of a power bank, the flow of power delivery may be in both directions depending on whether the power bank is operating as a power provider (e.g., to power another device) or as a power consumer (e.g., to get charged itself). For these reasons, the various applications of system 500 should be regarded in an illustrative rather than a restrictive sense.

FIG. 6 is a block diagram of an example system 600 for implementing a secondary-side peak current control mode flyback converter, according to some embodiments. For example, system 600 can be implemented within a secondary side of a flyback converter, such as secondary side 120 of FIGS. 1-3B. System 600 can correspond to secondary side 300A of FIG. 3A or secondary side 300B of FIG. 3B.

Referring back to FIG. 6, as shown, system 600 can include firmware 602. Firmware 602 can maintain a set of parameters. For example, firmware 602 can maintain at least Lₚᵣᵢ and L_{sec}. Additionally, firmware 602 can maintain a turns ratio corresponding to the flyback transformer. System 600 can further include secondary controller (SC) 604, feedforward component 606 and V_{OUT} unit 608. Feedforward component 606 can be used to determine V_{IN} 603. SC 604 can output Lₚᵣᵢ 605-1 and L_{sec} 605-2, as well as first time (t₁) 607-1 and second time (t₂) 607-2. More specifically, first time 607-1 is a power switch turn on time of a power switch of the primary side, and second time 607-2 is an SR switch on time. V_{OUT} unit 608 can measure V_{OUT} 609 (e.g., VBUS).

System 600 can further include integrators 610-1 and 610-2. In some embodiments, at least one of integrator 610-1 or integrator 610-2 is an analog circuit. In some embodiments, at least one of integrator 610-1 or integrator 610-2 is a digital circuit. For example, at least one of integrator 610-1 or integrator 610-2 can be developed as a resistor-transistor logic (RTL) digital circuit. Integrator 610-1 can integrate V_{IN} 603, Lₚᵣᵢ 605-1 and first time 607-1 to generate a first ramp voltage waveform having a positive slope proportional to the ratio of V_{IN} 603 and Lₚᵣᵢ 605-1 (e.g., t₁*(V_{IN}/Lₚᵣᵢ)). Integrator 610-2 can integrate V_{OUT} 609, L_{sec} 605-2 and second time 607-1 to generate a second ramp voltage waveform having a negative slope proportional to the ratio of V_{OUT} 609 and L_{sec} 605-2 (e.g., t₂*(V_{OUT}/L_{sec}). System 600 can further include subtractor 612 that, at the beginning of a next cycle, can determine the difference between the output of integrators 610-1 and 610-2 as a generate residual voltage (V_{R}) 614 used to define a starting voltage for the PWM ramp voltage for the next cycle. System 600 can further include PWM integrator 616 that integrates V_{IN} 603 and V_{R} 614 to generate PWM signal 618 for the next cycle. Accordingly, embodiments described herein can be implemented by a system similar to system 300A or 300B as described above with reference to FIGS. 3A and 3B, or can be implemented as an analog and/or digital system similar to system 600 as described in the FIG. 6.

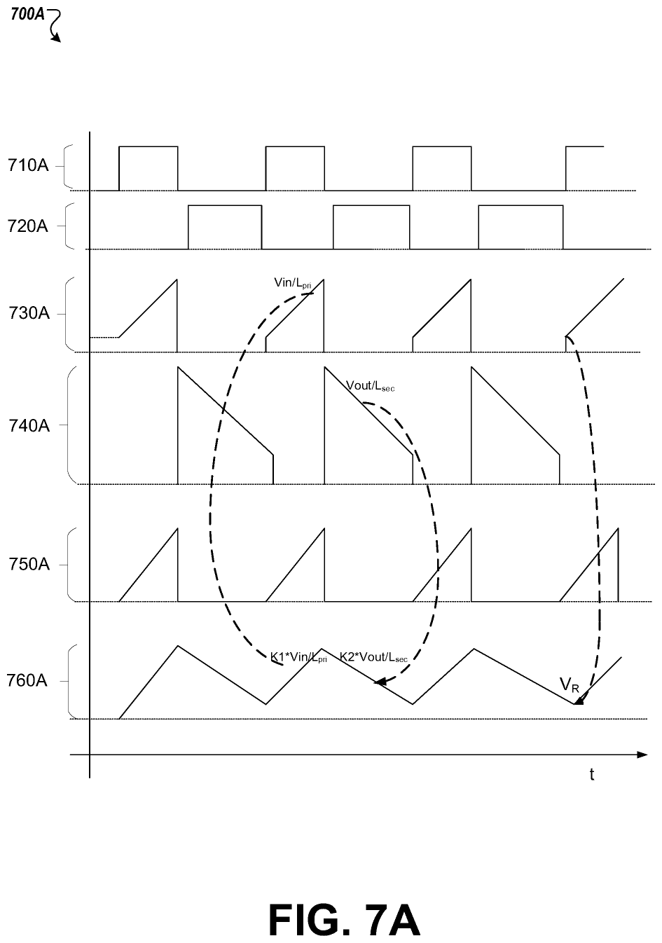

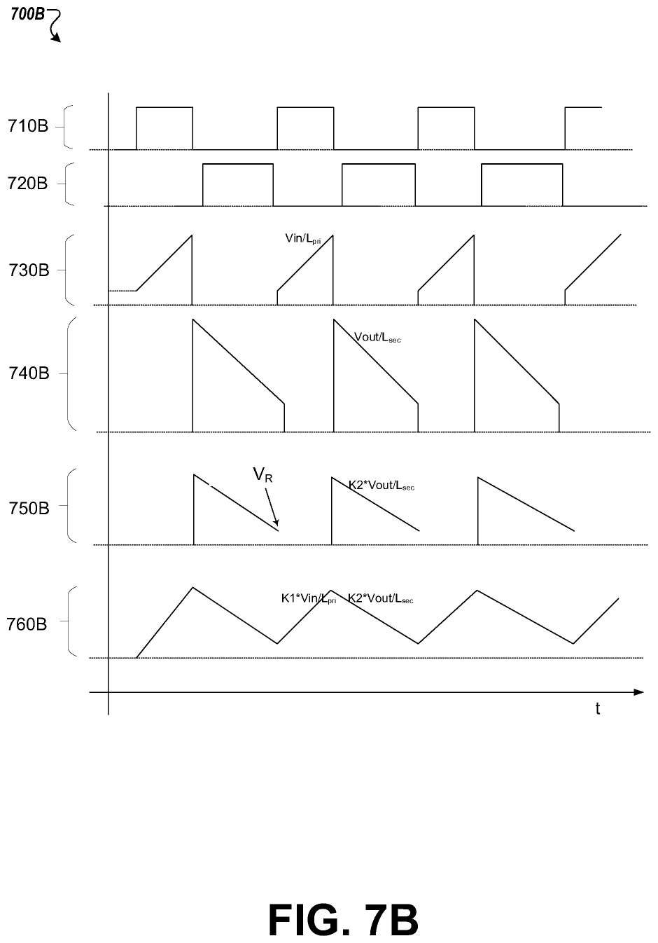

FIG. 7A are graphs 700A illustrating example waveforms, according to some embodiments. For example, graphs 700A can represent waveforms generated using system 300A of FIG. 3A. Referring back to FIG. 7A, as shown, graphs 700A include primary gate voltage waveform 710A, SR FET gate voltage waveform 720A, primary current waveform 730A, secondary current waveform 740A, PWM voltage mode voltage waveform 750A, and PWM current mode voltage waveform 760A over time (t). When a power switch is turned on, primary current waveform 730A ramps up a rate of V_{IN}/Lₚᵣᵢ and goes to zero when the power switch is turned off. When the power switch is turned off, secondary current waveform 740A starts at a non-zero current and ramps down at a rate of V_{OUT}/L_{sec} until the power switch turns on again. The time between when the power switch turns off and on forms a cycle.

PWM voltage mode voltage waveform 750A illustrates a waveform generated by a secondary-side controller operating in a voltage mode. As shown, the voltage of waveform 750A ramps up when the power switch is turned on, and then falls to zero when the power switch is turned off. In contrast, PWM current mode voltage waveform 760A illustrates a waveform generated by a secondary-side controller operating in a current mode. As shown, when the power switch is turned on, the voltage of waveform 760A is ramped up at a rate proportional to V_{IN}/Lₚᵣᵢ (K₁*V_{IN}/Lₚᵣᵢ, where K₁ is a positive number). When the power switch is turned off, the voltage of waveform 760A is ramped down at a rate proportional to V_{OUT}/L_{sec} (K₂*V_{OUT}/L_{sec}). The residual voltage V_{R} is the starting voltage of the next cycle. K₁ and K₂ are respective gain values of the ramp that can be determined based on the flyback converter to determine stability and transient response. K₁ and K₂ can be programmable based on user preference. In some embodiments, K₁ is equal to K₂. In some embodiments, K₁ is different from K₂.

FIG. 7B are graphs 700B illustrating example waveforms, according to some embodiments. For example, graphs 700B can represent waveforms generated using system 300B of FIG. 3B. Referring back to FIG. 7B, as shown, graphs 700B include primary gate voltage waveform 710B, SR FET gate voltage waveform 720B, primary current waveform 730B, secondary current waveform 740B, gain amplifier voltage waveform 750B, and PWM current mode voltage waveform 760B over time (t). When a power switch is turned on, primary current waveform 730B is ramped up a rate of V_{IN}/Lₚᵣᵢ and goes to zero when the power switch is turned off. When the power switch is turned off, secondary current waveform 740B starts at a non-zero voltage and is ramped down at a rate of V_{OUT}/L_{sec} until the power switch turns on again. The time between when the power switch turns off and on forms a cycle.

Gain amplifier voltage waveform 750B illustrates a waveform generated by a gain amplifier of a secondary-side controller (e.g., gain amplifier 395 of FIG. 3B). Referring back to FIG. 7B, as shown, the voltage of waveform 750B starts at a non-zero voltage when the power switch is turned off, and is ramped down at a rate proportional to V_{OUT}/L_{sec} (K₂*V_{OUT}/L_{sec}) until the power switch turns on. The residual voltage (V_{R}) is the starting voltage of waveform 750B during the next cycle when the power switch is turned on. PWM current mode voltage waveform 760B illustrates a waveform generated by a secondary-side controller operating in a current mode. As shown, when the power switch is turned on, the voltage of waveform 760B ramps up at a rate proportional to V_{IN}/Lₚᵣᵢ (K₁*V_{IN}/Lₚᵣᵢ). When the power switch is turned off, the voltage of waveform 760B ramps down at a rate proportional to V_{OUT}/L_{sec} (K₂*V_{OUT}/L_{sec}).

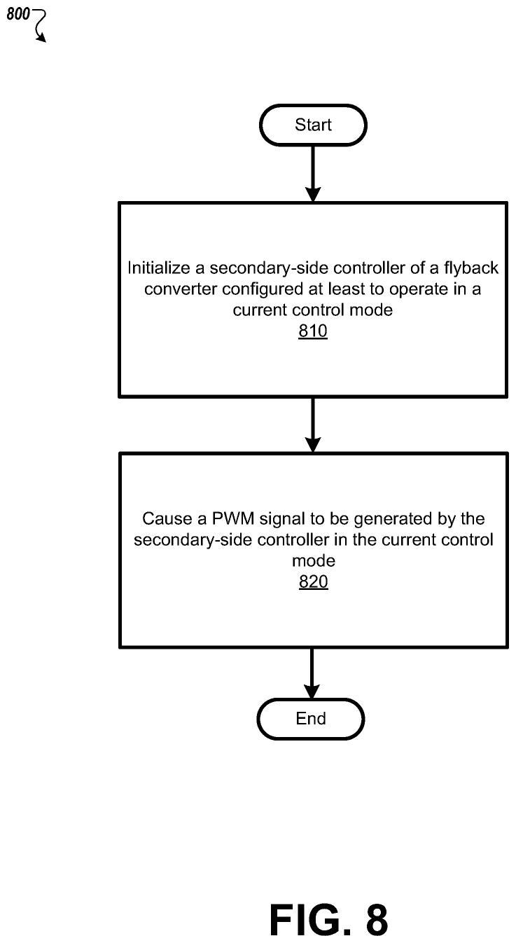

FIG. 8 is a flow diagram of an example method 800 of implementing a secondary side peak current controlled flyback converter, according to some embodiments. Method 800 may be performed by at least one processing device that comprises hardware (e.g., circuitry, dedicated logic, programmable logic, microcode, etc.), software, firmware, or a combination thereof. In some embodiments, a secondary-side controller of a flyback converter performs method 800 (e.g., secondary-side controller 126 of FIGS. 1, 2A, 2B, and 4). In some embodiments, peripheral subsystem 510 of FIG. 5 performs method 800.

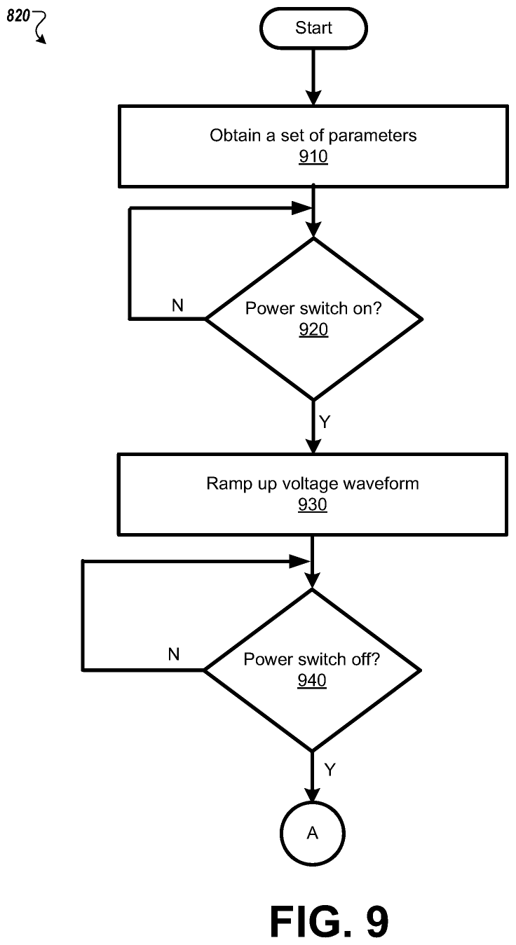

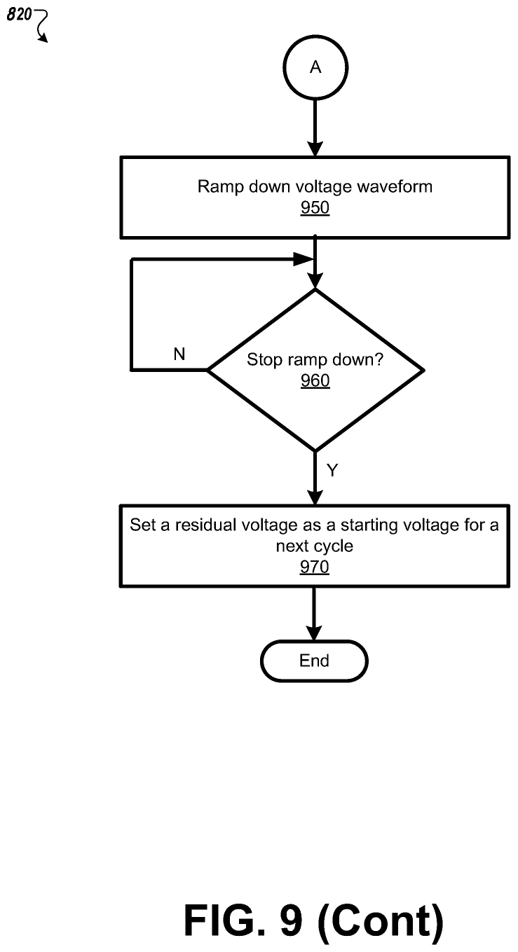

At operation 810, processing logic initializes a secondary-side controller of a flyback converter configured to at least operate in a current control mode. At operation 820, processing logic causes a PWM signal to be generated by the secondary-side controller in the current control mode. For example, as described above with reference to FIGS. 1-7B and as will now be described in further detail below with reference to FIG. 9, the PWM signal can be generated based on a set of parameters. For example, a voltage waveform can be ramped up at a rate (e.g., slope) proportional to V_{IN} and (Lₚᵣᵢ) when a power switch of the primary side is on (e.g., when an SR switch (e.g., SR FET) of the secondary side is off). The voltage waveform can be ramped down at a rate proportional to V_{OUT} and (L_{sec}) when the power switch is off (e.g., when the SR switch of the secondary side is on).

FIG. 9 is a flow diagram of an example method 820 of causing a PWM signal to be generated by a secondary-side controller in a current control mode, according to some embodiments. Method 820 may be performed by at least one processing device that comprises hardware (e.g., circuitry, dedicated logic, programmable logic, microcode, etc.), software, firmware, or a combination thereof. In some embodiments, a secondary-side controller of a flyback converter performs method 820 (e.g., secondary-side controller 126 of FIGS. 1, 2A, 2B, and 4). In some embodiments, peripheral subsystem 510 of FIG. 5 performs method 820.

At operation 910, processing logic obtains a set of parameters. The set of parameters can include Lₚᵣᵢ, L_{sec}, V_{IN} and V_{OUT} (e.g., VBUS). In some embodiments, obtaining the set of parameters includes loading Lₚᵣᵢ and L_{sec} from firmware. In some embodiments, obtaining the set of parameters includes obtaining V_{IN} from feedforward circuitry. More specifically, the feedforward circuitry can derive V_{IN} from a sense node (e.g., SR drain node) In some embodiments, obtaining the set of parameters includes obtaining V_{OUT} from an error amplifier. In some embodiments, obtaining the set of parameters includes loading V_{OUT} from firmware.

At operation 920, processing logic determines whether a power switch is on. More specifically, the power switch is a switch of a primary side of the flyback converter coupled to a primary-side controller. For example, the primary-side controller can include a gate driver. The process waits until the power switch is turned on. An SR switch (e.g., SR FET) of the secondary side can be off while the power switch is on.

In response to determining that the power switch is on, at operation 930, processing logic ramps up a voltage waveform. More specifically, processing logic causes the voltage waveform to be ramped up a first rate (e.g., slope) proportional to V_{IN} and Lₚᵣᵢ (e.g., K₁*V_{IN}/Lₚᵣᵢ).

At operation 940, it is determined whether the power switch is turned off. The SR switch can be on while the power switch is off. If the power switch is not determined to be turned off (i.e., the power switch is still on), then the voltage waveform can continue to be ramped up at the first rate. If the power switch is determined to be turned off at operation 940, then processing logic ramps down the voltage waveform at operation 950. More specifically, processing logic causes the voltage waveform to be ramped down at a second rate (e.g., slope) proportional to V_{OUT} and L_{sec} (e.g., K₂*V_{OUT}/L_{sec}).

At operation 960, it is determined whether to stop ramping down the voltage waveform. In some embodiments, determining whether to stop ramping down the voltage waveform includes determining whether the power switch is turned on. In some embodiments, determining whether to stop ramping down the voltage waveform includes determining whether a zero-crossing is detected using ZCD. If a determination is not made to stop ramping down the voltage waveform, then the voltage waveform can continue to be ramped down at the second rate.

Otherwise, at operation 970, a residual voltage is set as a starting voltage for a next cycle. More specifically, the residual voltage is a residual voltage between the ramped up voltage waveform and the ramped down voltage waveform. The next cycle can then be initiated. Further details regarding operations 910-970 are described above with reference to FIGS. 1-8.

In the above description, some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

However, it should be borne in mind that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “adjusting,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance, or illustration. Any aspect or design described herein as “example” or “exemplary” is not necessarily to be construed as preferred or advantageous over other aspects or designs. Rather, the use of the words “example” or “exemplary” is intended to present concepts concretely. As used in this application, the term “or” is intended to mean an inclusive “or” rather than an exclusive “or.” Unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an embodiment” or “one embodiment” throughout is not intended to mean the same embodiment or embodiment unless described as such.

The preceding description sets forth numerous specific details, such as examples of specific systems, components, methods, and so forth, in order to provide a good understanding of various embodiments of the techniques described herein for current control mode operation in secondary-side controllers, such as used in USB power delivery applications. However, it will be apparent to one skilled in the art that at least some embodiments may be practiced without these specific details. In other instances, well-known components, elements, or methods are not described in detail or are presented in a simple block diagram format in order to avoid unnecessarily obscuring the techniques described herein. Thus, the specific details set forth hereinafter are merely exemplary. Particular implementations may vary from these exemplary details and still be contemplated to be within the spirit and scope of the present invention.

Reference in the description to “an embodiment,” “one embodiment,” “an example embodiment,” “some embodiments,” and “various embodiments” means that a particular feature, structure, step, operation, or characteristic described in connection with the embodiment(s) is included in at least one embodiment of the invention. Further, the appearances of the phrases “an embodiment,” “one embodiment,” “an example embodiment,” “some embodiments,” and “various embodiments” in various places in the description do not necessarily all refer to the same embodiment(s).

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

The above description sets forth numerous specific details, such as examples of specific systems, components, methods, and so forth, in order to provide a good understanding of several embodiments of the present disclosure. It is to be understood that the above description is intended to be illustrative and not restrictive. Many other embodiments will be apparent to those of skill in the art upon reading and understanding the above description. Therefore, the disclosure scope should be determined with reference to the appended claims, along with the full scope of equivalents to which such claims are entitled.

What is claimed is:

1. An apparatus comprising:
a flyback converter comprising:
a flyback transformer and a signal transformer;
a primary side comprising a primary-side controller coupled to a power switch, the flyback transformer and the signal transformer; and
a secondary side comprising a secondary-side controller coupled to the flyback transformer and the signal transformer, wherein the secondary-side controller is configured at least to operate in a current control mode to cause a pulse width modulation (PWM) signal to be generated based on a set of parameters to control operation of the primary-side controller.

2. The apparatus of claim 1, wherein the flyback converter operates in a continuous conduction mode (CCM).

3. The apparatus of claim 1, wherein the flyback converter operates in a discontinuous conduction mode (DCM).

4. The apparatus of claim 1, wherein, to cause the PWM signal to be generated in the current control mode, the secondary-side controller is further configured to:
obtain a set of parameters;
determine whether the power switch is on; and
in response to determining that the power switch is on, cause a voltage waveform to be ramped up based on the set of parameters.

5. The apparatus of claim 4, wherein:
the set of parameters comprises an input voltage corresponding to an alternating current (AC) voltage input (V_{IN}), and a primary inductance with respect to the flyback transformer (Lₚᵣᵢ); and
the voltage waveform is ramped up at a rate proportional to a ratio of V_{IN} and Lₚᵣᵢ.

6. The apparatus of claim 5, wherein the secondary-side controller comprises feedforward circuitry to obtain V_{IN} from a sense node, and wherein Lₚᵣᵢ is loaded from firmware.

7. The apparatus of claim 4, wherein, to cause the PWM signal to be generated in the current control mode, the secondary-side controller is further configured to:
determine whether the power switch is off; and
in response to determining that the power switch off, cause the voltage waveform to be ramped down based on the set of parameters.

8. The apparatus of claim 7, wherein:
the set of parameters further comprises an output voltage (V_{OUT}), and a secondary inductance with respect to the flyback transformer (L_{sec}); and
the voltage waveform is ramped down at a rate proportional to a ratio of V_{OUT} and L_{sec}.

9. The apparatus of claim 8, wherein L_{sec} is loaded from firmware, and wherein V_{OUT} is obtained from the firmware or an error amplifier of the secondary-side controller.

10. The apparatus of claim 7, wherein, to cause the PWM signal to be generated in the current control mode, the secondary-side controller is further configured to:
determine whether to stop the voltage waveform being ramped down; and
in response to stopping the voltage waveform being ramped down, set a residual voltage as a starting voltage for a next cycle.

11. The apparatus of claim 10, wherein the flyback converter operates in a continuous conduction mode (CCM), and wherein determining whether to stop the voltage waveform being ramped down comprises determining whether the power switch is turned on.

12. The apparatus of claim 10, wherein the flyback converter operates in a discontinuous conduction mode (DCM), and wherein determining whether to stop the voltage waveform being ramped down comprises determining whether a zero-crossing is detected.

13. The apparatus of claim 1, wherein the apparatus comprises a Universal Serial Bus Power Delivery (USB-PD) power adapter.

14. A method comprising:
initializing a secondary-side controller of a Universal Serial Bus Power Delivery (USB-PD) flyback converter configured to operate in a current control mode, wherein the USB-PD flyback converter further comprises a flyback transformer and a signal transformer coupled to the secondary-side controller, and a primary-side controller coupled to a power switch, the flyback transformer, and the signal transformer; and
causing a pulse width modulation (PWM) signal to be generated in the current control mode to control operation of the primary-side controller.

15. The method of claim 14, wherein causing the PWM signal to be generated in the current control mode further comprises:
obtaining a set of parameters, the set of parameters comprising an input voltage corresponding to an alternating current (AC) voltage input (V_{IN}), a primary inductance with respect to the flyback transformer (Lₚᵣᵢ), an output voltage (V_{OUT}), and a secondary inductance with respect to the flyback transformer (L_{sec});
determining whether the power switch is on; and
in response to determining that the power switch is on, causing a voltage waveform to be ramped up at a rate proportional to a ratio of V_{IN} and Lₚᵣᵢ.

16. The method of claim 15, wherein causing the PWM signal to be generated in the current control mode further comprises:
determining whether the power switch is off; and
in response to determining that the power switch off, causing the voltage waveform to be ramped down at a rate proportional to a ratio of V_{OUT} and L_{sec}.

17. The method of claim 16, wherein causing the PWM signal to be generated in the current control mode further comprises:
determining whether to stop the voltage waveform being ramped down; and
in response to stopping the voltage waveform being ramped down, setting a residual voltage as a starting voltage for a next cycle.

18. The method of claim 17, wherein the USB-PD flyback converter operates in a continuous conduction mode (CCM), and wherein determining whether to stop the voltage waveform being ramped down comprises determining whether the power switch is turned on.

19. The method of claim 17, wherein the USB-PD flyback converter operates in a discontinuous conduction mode (DCM), and wherein determining whether to stop the voltage waveform being ramped down comprises determining whether a zero-crossing is detected.

20. A power adapter comprising:
a rectifier configured to generate a direct current (DC) output based on an alternating current (AC) input received from an AC source; and
a flyback converter configured to operate in a secondary-side controlled mode, the flyback converter comprising:
a flyback transformer;
a signal transformer;
a primary side comprising:
a primary-side controller coupled to the flyback transformer and the signal transformer; and
a power switch coupled to the primary-side controller; and
a secondary side comprising a secondary-side controller coupled to the flyback transformer and the signal transformer, wherein the secondary-side controller is configured at least to operate in a current control mode to cause a pulse width modulation (PWM) signal to be generated based on a set of parameters to control operation of the primary-side controller.
